(19) United States
(12) Patent Application Publication
(10) Pub. No.: US 2008/0294442 A1
(43) Pub. Date: Nov. 27, 2008

(54) APPARATUS, METHOD AND SYSTEM

(75) Inventor: Kaj Makela, Helsinki (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 12/109,732

(22) Filed: Apr. 25, 2008

Related U.S. Application Data
(60) Provisional application No. 60/914,102, filed on Apr. 26, 2007.

(51) Int. Cl. G10L 13/08

(52) U.S. Cl. 704/260; 704/E13.001

(57) ABSTRACT

A method includes obtaining digital content comprising text content; obtaining at least one speech parameter associated with the digital content; and using the speech parameters as an input, generating a speech output corresponding to at least part of the text content. Corresponding apparatuses, system and computer program products are also presented.

### CROSS-REFERENCE TO RELATED APPLICATIONS

This application claims priority to, and the benefit of, U.S. Provisional Patent Application No. 60/914,102, filed on Apr. 26, 2007, the disclosure of which is incorporated herein by reference in its entirety.

### FIELD

The disclosed embodiments generally relate to speech synthesis, and particularly to text-to-speech speech synthesis.

### BACKGROUND

Speech synthesis is the artificial generation of human speech. One aspect of speech synthesis is text-to-speech technologies, where a text is used as an input to a speech synthesizer, generating an audio signal containing a voice speaking the text.

A problem in the prior art is how to make the speech synthesis more personal and enjoyable. One way to alleviate this is presented in Macintosh OS X, where the user is presented with a choice of system voices to perform the speaking, e.g. Bruce, Vicki, etc. However, the result of the speech synthesis is still somewhat impersonal.

Consequently, there is a need to provide a method to increase usability and friendliness of synthesized speech.

### SUMMARY

According to a first aspect of the disclosed embodiments there has been provided a method comprising: obtaining digital content comprising text content; obtaining at least one speech parameter associated with the digital content; and using the speech parameters as an input, generating a speech output corresponding to at least part of the text content.

At least part of the speech parameters may represent characteristics of a voice corresponding to a person.

The digital content may be associated with the person.

The digital content may be content selected from the group comprising a hypertext markup language document, an email, a short message, and a multimedia message.

The obtaining at least one speech parameter may involve: obtaining a reference to the at least one speech parameter from the digital content, the reference being a reference to a resource on a computer network, and downloading the at least one speech parameter from a computer associated with the reference over the computer network.

The obtaining the reference may involve obtaining the reference from a header field in the digital content.

The reference may comply with the form of a uniform resource indicator.

The obtaining at least one speech parameter may involve: obtaining the at least one speech parameter from a part of the digital content.

The at least one speech parameter may be included in an attachment of the digital content.

The at least one speech parameter may be included in a cascading style sheet associated with the digital content.

The method may be executed in a mobile communication terminal.

A second aspect of the disclosed embodiments is directed to an apparatus comprising: a controller, the controller being configured to obtain digital content comprising text content; the controller being further configured to obtain at least one speech parameter associated with the digital content; and the controller being further configured to, using the speech parameters as an input, generate a speech output corresponding to at least part of the digital content.

At least part of the speech parameters may represent characteristics of a voice associated with a person.

The at least part of digital content may be associated with the person.

The digital content may be content selected from the group comprising a hypertext markup language document, an email, an extensible markup language document, a short message and a multimedia message.

The at least one speech parameter may be available using a reference obtainable from the digital content, the reference being a reference to a resource on a computer network, and the controller may be further configured to download the at least one speech parameter from a computer associated with the reference over the computer network.

The reference may be included in a header field in the digital content.

The reference may comply with the form of a uniform resource indicator.

The resource may comprise a cascading style sheet.

The at least one speech parameter may be included in the digital content.

The at least one speech parameter may be included in an attachment of the digital content.

The at least one speech parameter may be included in a header field in the digital content.

The at least one speech parameter may be included in a tag in a markup language included in the digital content.

The apparatus may be comprised in a mobile communication terminal.

A third aspect of the disclosed embodiments is directed to an apparatus comprising: means for obtaining digital content comprising text content; means for obtaining at least one speech parameter associated with the digital content; and means for, using the speech parameters as an input, generating a speech output corresponding to at least part of the text content.

A fourth aspect of the disclosed embodiments is directed to an apparatus comprising a controller, the controller being configured to associate digital content comprising text content with at least one speech parameter; and the controller being further configured to send the digital content, including the association with the at least one speech parameter.

A fifth aspect of the disclosed embodiments is directed to a system comprising a transmitter comprising: a transmitter controller, the transmitter controller being further configured to associate digital content comprising text content with at least one speech parameter; and the transmitter controller being configured to send the digital content, including the association with the at least one speech parameter, and a receiver comprising: a receiver controller, the receiver controller being configured to obtain the digital content; the receiver controller being further configured to obtain the at least one speech parameter associated with the digital content; and the receiver controller being further configured to, using the speech parameters as an input, generate a speech output corresponding to at least part of the digital content.

A sixth aspect of the disclosed embodiments is directed to a computer program product comprising software instructions that, when executed in a mobile communication terminal, performs the method according to the first aspect.

When the term “text” is used herein, it is to be interpreted as any combination of symbols representing parts of language.

Other aspects, features and advantages of the disclosed embodiments will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects of the disclosed embodiments will now be described in more detail, reference being made to the enclosed drawings, in which:

FIG. 1 is a schematic illustration of a cellular telecommunication system, as an example of an environment in which the disclosed embodiments may be applied.

FIG. 2 is a schematic front view illustrating a mobile terminal according to an embodiment.

FIG. 3 is a schematic block diagram representing an internal component, software and protocol structure of the mobile terminal shown in FIG. 2.

FIG. 4 is a flow chart illustrating a context comparison in the terminal of FIG. 2.

FIG. 5 shows a table that can be used in the process illustrated in FIG. 4.

FIG. 6 is a schematic diagram illustrating how content is related to speech parameters in the terminal of FIG. 2.

### DETAILED DESCRIPTION OF THE DISCLOSED EMBODIMENTS

The disclosed embodiments will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

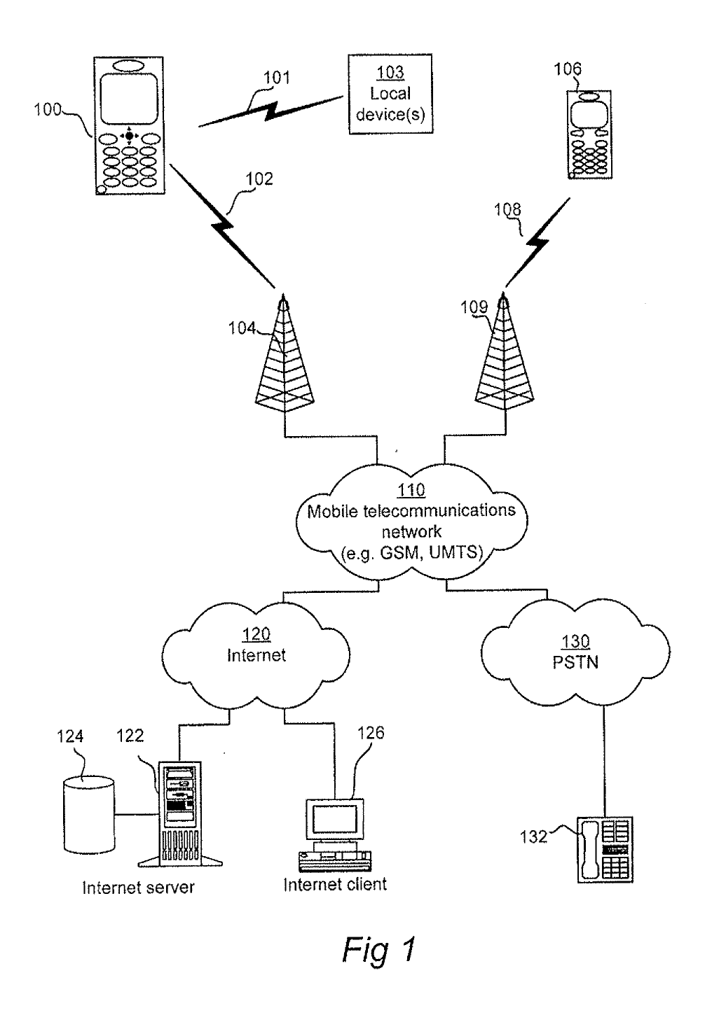

FIG. 1 illustrates an example of a cellular telecommunications system in which the invention may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between an apparatus being a mobile terminal (or mobile communication terminal) 100 being a portable apparatus according to the present invention and other devices, such as another mobile terminal 106 or a stationary telephone 132. It is to be noted that for different embodiments of the mobile terminal 100 and in different situations, different ones of the telecommunications services referred to above may or may not be available; the invention is not limited to any particular set of services in this respect.

The mobile terminals 100, 106 are connected to a mobile telecommunications network 110 through RF links 102, 108 via base stations 104, 109. The mobile telecommunications network 110 may be in compliance with any commercially available mobile telecommunications standard, such as GSM, UMTS, D-AMPS, CDMA2000, FOMA and TD-SCDMA.

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100. A connection thus exists between the mobile terminal 100 and the Internet server 122, which can for example host discussion forums or blogs.

A public switched telephone network (PSTN) 130 is connected to the mobile telecommunications network 110 in a familiar manner. Various telephone terminals, including the stationary telephone 132, are connected to the PSTN 130.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network (WLAN) link, an RS-232 serial link, etc. The local devices 103 can for example be various sensors that can communicate measurement values to the mobile terminal 100 over the local link 101.

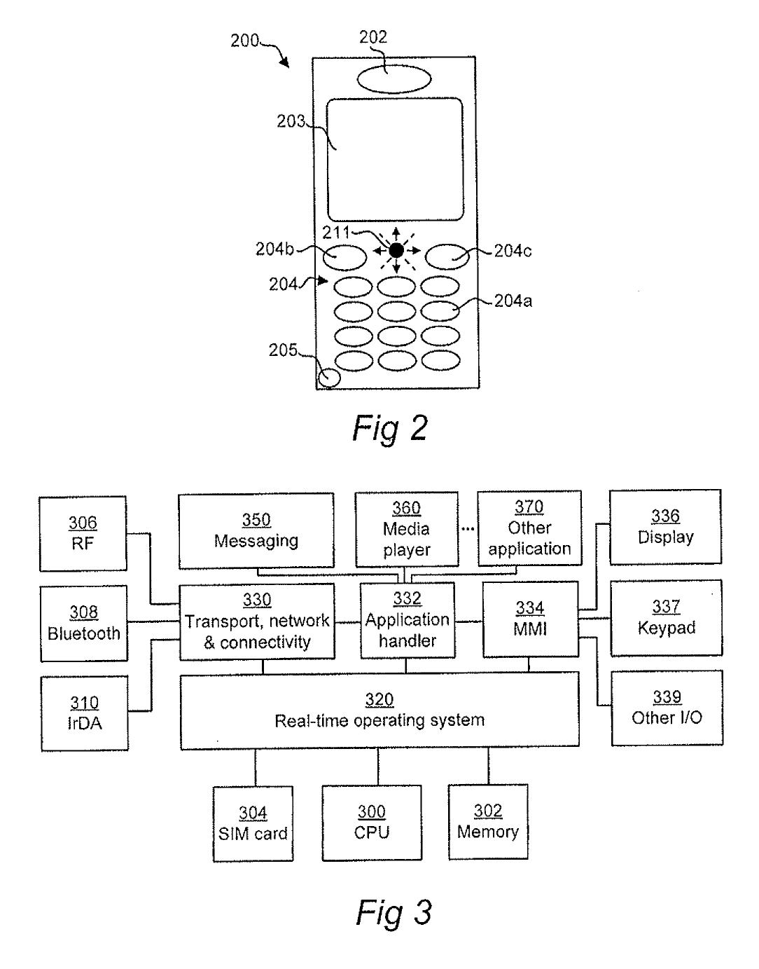

An embodiment 200 of the mobile terminal 100 is illustrated in more detail in FIG. 2. The mobile terminal 200 comprises a speaker or earphone 202, a microphone 205, a display 203 and a set of keys 204 which may include a keypad 204a of common ITU-T type (alpha-numerical keypad representing characters “0”-“9”, “*” and “#”) and certain other keys such as soft keys 204b, 204c and a joystick 211 or other type of navigational input device. The display 203 may be a regular display or a touch-sensitive display.

The internal component, software and protocol structure of the mobile terminal 200 will now be described with reference to FIG. 3. The mobile terminal has a controller 300 which is responsible for the overall operation of the mobile terminal and is preferably implemented by any commercially available CPU (“Central Processing Unit”), DSP (“Digital Signal Processor”) or any other electronic programmable logic device. The controller 300 has associated electronic memory 302 such as RAM memory, ROM memory, EEPROM memory, flash memory, or any combination thereof. The memory 302 is used for various purposes by the controller 300, one of them being for storing data and program instructions for various software in the mobile terminal. The software includes a real-time operating system 320, drivers for a man-machine interface (MMI) 334, an application handler 332 as well as various applications. The applications can include a messaging application 350, a media player application 360, as well as various other applications 370, such as applications for voice calling, video calling, web browsing, an instant messaging application, a contact application, a calendar application, a control panel application, a camera application, one or more video games, a notepad application, etc.

The MMI 334 also includes one or more hardware controllers, which together with the MMI drivers cooperate with the display 336/203, keypad 337/204 as well as various other I/O devices 339 such as microphone, speaker, vibrator, ringtone generator, LED indicator, motion sensor etc. The user may operate the mobile terminal through the man-machine interface thus formed. One aspect of this user interface is speech synthesis, which is software and/or hardware providing the ability to synthesize speech from text.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. Additionally, communication can be configured for other communication protocols, such as wireless local area network, IEEE 802.11 (not shown) or to receive location information through for example a global positioning system (GPS) (not shown). The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, i.a., band pass filters, amplifiers, mixers, local oscillators, low pass filters, AD/DA converters, etc.

The mobile terminal also has a SIM card 304 and an associated reader. As is commonly known, the SIM card 304 comprises a processor as well as local work and data memory.

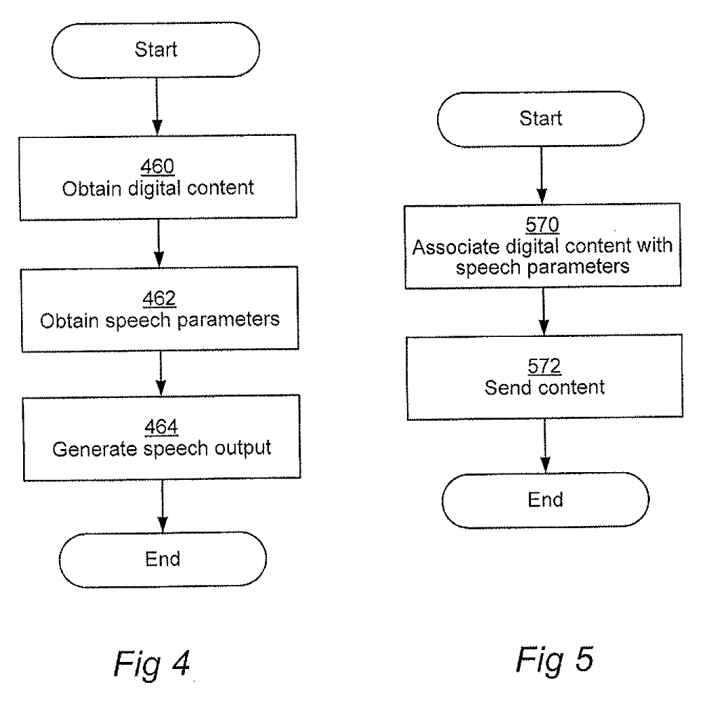

FIG. 4 is a flow chart illustrating speech synthesis in the terminal of FIG. 2. The terminal can also be referred to as a receiver, as content is received in the mobile terminal.

In an obtain digital content step 460, digital content is obtained. The content has the ability to be converted to speech and as such includes text of some sort. Any suitable content is within the scope of this document. However, for purposes of illustration, a limited number of examples will be discussed herein. A first example is when the content is an email, a second example is when the content is a web page, a.k.a. hypertext markup language (HTML) page, and a third example is when the content is a text message (SMS). Additionally, extensible markup language documents could hold the content. The content is obtained in the mobile terminal according to conventional protocols and standards.

In an obtain speech parameters step 462, at least one (and typically more) speech parameter are obtained, where the speech parameters are related to the content. The speech parameters are used at a later stage to affect the way speech is synthesized. The speech parameters can for example affect pitch, speed, accent on a general level, or more specific prosodic features. Using the speech parameters, the speech synthesizer can generate speech which has similarities of a certain person or a certain mood. Alternatively, the speech can resemble a specific synthesized voice, not directly related to a person, e.g. a robot.

In one embodiment, it is determined that the obtained content is related to a specific person, such as a sender of a message, an author of a document or an owner of a document. Once the person is determined, the mobile terminal determines speech parameters which are associated with the person. For example, in the first example where the content is an email or in the third example when the content is a text message, if there is an entry representing the sender in the phone book application of the mobile terminal, that entry can have a uniform resource indicator (URI) referring to speech parameters for that person. Alternatively, in the first example when the content is an email or in the second example when the content is an HTML-page, a header in the document may indicate the source of the speech parameters to use. In this example, the speech parameters are not necessarily associated with a person. For instance, if the content is an HTML-page with a poem, the author may include a header with URI to speech parameters appropriate for the mood of the poem. When a reference, such as a URI or a URL, to speech parameters is determined, the mobile terminal subsequently downloads the speech parameters from the server, such as server 122 (FIG. 1), over a computer network, such as the wide area network 120 (FIG. 1) according to the URI. Instead of using a URI, a reference could alternatively be made to speech parameters stored in the memory 302 (FIG. 3) of the mobile terminal. In one embodiment, the speech parameters are attached to the content itself (e.g. as a plain text file, an XML-file or a style sheet file), or the parameters themselves are contained in headers of the content. Alternatively, the speech parameters may be embedded in the text, e.g. as part of tags in a markup language. This allows different speech parameters to be used for different parts of the document.

Optionally, different speech parameters are retrieved from different sources. For example, one source may have parameters related to voice timbre, while another source may have parameters related to prosody, accent, tempo, mood parameters, etc.

In one embodiment, as the content is associated to a person, the receiver may apply these also to map own sounds to the content related to this person. E.g. Mark sends Lucy an e-mail referring his parameters sounding like Mickey Mouse. However, Lucy's system can replace the parameters, using the identifier of Mark, and perform an overriding mapping in the receiver. So if Lucy may have an overriding mapping for Mark, whereby she hears Mark's voice as Homer Simpson.

In one embodiment, parameters of a person may be dynamic. A person's sound could thus change depending on the current state/presence information of the person e.g. walking vs. jogging. The speech parameters then act as secondary cues, providing additional information to the receiver. For example, the sender of an email is now in a hurry, sad/happy (emotions/affective computing). In that case the parameters can be push-delivered and changes should be reacted accordingly during the process. The source of parameter information can be an application, not only a document.

When the content and the speech parameters have been obtained, the speech is generated in the generate speech output step 464. The speech generator typically generates speech from a part of the text of the content, while taking the speech parameters into consideration. Consequently, the generated speech has characteristics which are affected by the speech parameters. During the speech generation, the user can pause, stop and even rewind the generated speech.

An associated method for use in a transmitter will now be described with reference to FIG. 5. The transmitter can for example be a server, a desktop computer, a laptop computer, a pocket computer, a mobile terminal, etc.

In an associate digital content with speech parameters step 570, speech parameters as indicated by the user are associated with the content in question. The speech parameters can be associated with an explicit action from the user, or implicitly, using the identity of the user, where the user is always associated with a set of speech parameters. The parameters are technically associated with the content in accordance to the technical aspects described in conjunction with the obtain speech parameters step 462 above.

In the send content step 572, the content is sent. The sending can either be push-based, such as using email, MMS or SMS, or pull-based, such as hypertext transfer protocol (HTTP) or file transfer protocol (FTP), thus initiated from an external entity.

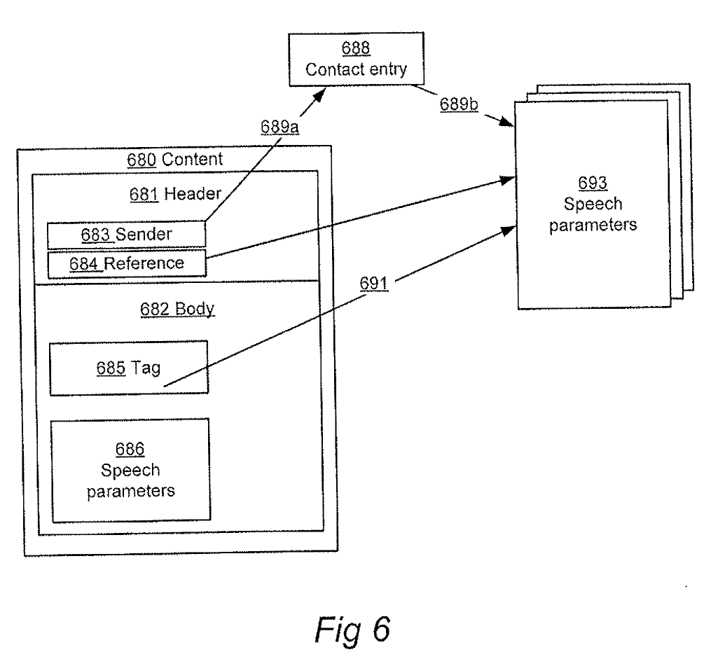

FIG. 6 is a schematic diagram illustrating how content is related to speech parameters in the terminal of FIG. 2. The content 680 can be any type of content as described in conjunction with step 460 above. The content can be divided into a header 681 and a body 682. In the header, there can be a sender identifier 683, such as a phone number or email address, whereby the mobile terminal can reference 689a a contact entry 688 from the contact application. The contact entry 688 can then have a reference to speech parameters 693. The speech parameters can be a cascading style sheet document, an xml-document, a plain text document or any other type of document suitable for containing the speech parameters.

Optionally or additionally, there is a direct reference 684 in the header to speech parameters 693 to be used for the content 680.

Optionally or additionally, the body 682 can contain a tag 685, with a reference 691 to speech parameters 693. If there are already speech parameters associated with the content 680 as a whole, the speech parameters 693 referenced in the tag 685 can take precedence.

Optionally or additionally, the body 682 can in itself contain speech parameters 686, in a format intelligible for the mobile terminal in order to synthesize speech according to these speech parameters 686. Optionally, these speech parameters can be located in the header 681.

It is to be noted that each reference to speech parameters mentioned above can be to a separate document.

While the method illustrated above is performed in a mobile terminal, it is to be noted that the invention is applicable to suitable digital processing environment, such as, but not limited to, a desktop computer, a laptop computer, a pocket computer, a server, and an MP3-player.

The invention has mainly been described above with reference to a few embodiments. However, as is readily appreciated by a person skilled in the art, other embodiments than the ones disclosed above are equally possible within the scope of the invention, as defined by the appended patent claims.

What is claimed is:

1. A method comprising:
obtaining digital content comprising text content;
obtaining at least one speech parameter associated with at least part of said digital content; and
using said speech parameters as an input, generating a speech output corresponding to text comprised in said at least part of said text content.

2. The method according to claim 1, wherein at least part of said speech parameters represent characteristics of a voice associated with a person.

3. The method according to claim 2, wherein said at least part of digital content is associated with said person.

4. The method according to claim 1, wherein said digital content is content selected from the group comprising a hypertext markup language document, an email, an extensible markup language document, a short message and a multimedia message.

5. The method according to claim 1, wherein said obtaining at least one speech parameter involves:
obtaining a reference to said at least one speech parameter from said digital content, said reference being a reference to a resource on a computer network, and
downloading said at least one speech parameter from a computer associated with said reference over said computer network.

6. The method according to claim 5, wherein said obtaining said reference involves obtaining said reference from a header field in said digital content.

7. The method according to claim 5, wherein said reference complies with the form of a uniform resource indicator.

8. The method according to claim 5, wherein said resource comprises a cascading style sheet.

9. The method according to claim 1, wherein said obtaining at least one speech parameter involves:
obtaining said at least one speech parameter from a part of said digital content.

10. The method according to claim 9, wherein said at least one speech parameter is included in an attachment of said digital content.

11. The method according to claim 9, wherein said at least one speech parameter is included in a header field in said digital content.

12. The method according to claim 9, wherein said at least one speech parameter is included in a tag in a markup language included in said digital content.

13. The method according to claim 1, wherein said method is executed in a mobile communication terminal.

14. The method according to claim 1, wherein said step of obtaining at least one speech parameter involves obtaining at least one speech parameter from one resource and obtaining at least one speech parameter from another resource.

15. An apparatus comprising:
a controller,
said controller being configured to obtain digital content comprising text content;
said controller being further configured to obtain at least one speech parameter associated with said digital content; and
said controller being further configured to, using said speech parameters as an input, generate a speech output corresponding to at least part of said digital content.

16. The apparatus according to claim 15, wherein at least part of said speech parameters represent characteristics of a voice associated with a person.

17. The apparatus according to claim 16, wherein said at least part of digital content is associated with said person.

18. The apparatus according to claim 15, wherein said digital content is content selected from the group comprising a hypertext markup language document, an email, an extensible markup language document, a short message and a multimedia message.

19. The apparatus according to claim 15, wherein said at least one speech parameter is available using a reference obtainable from said digital content, said reference being a reference to a resource on a computer network, and
said controller is further configured to download said at least one speech parameter from a computer associated with said reference over said computer network.

20. The apparatus according to claim 19, wherein said reference is included in a header field in said digital content.

21. The apparatus according to claim 19, wherein said reference complies with the form of a uniform resource indicator.

22. The apparatus according to claim 19, wherein said resource comprises a cascading style sheet.

23. The apparatus according to claim 15, wherein said at least one speech parameter is included in said digital content.

24. The apparatus according to claim 23, wherein said at least one speech parameter is included in an attachment of said digital content.

25. The apparatus according to claim 23, wherein said at least one speech parameter is included in a header field in said digital content.

26. The apparatus according to claim 23, wherein said at least one speech parameter is included in a tag in a markup language included in said digital content.

27. The apparatus according to claim 15, wherein said apparatus is comprised in a mobile communication terminal.

28. An apparatus comprising:
means for obtaining digital content comprising text content;
means for obtaining at least one speech parameter associated with said digital content; and
means for, using said speech parameters as an input, generating a speech output corresponding to at least part of said text content.

29. An apparatus comprising
a controller,
said controller being configured to associate digital content comprising text content with at least one speech parameter; and
said controller being further configured to send said digital content, including said association with said at least one speech parameter.

30. A system comprising
a transmitter comprising:
a transmitter controller,
said transmitter controller being further configured to associate digital content comprising text content with at least one speech parameter; and
said transmitter controller being configured to send said digital content, including said association with said at least one speech parameter, and
a receiver comprising:
a receiver controller,
said receiver controller being configured to obtain said digital content;
said receiver controller being further configured to obtain said at least one speech parameter associated with said digital content; and
said receiver controller being further configured to, using said speech parameters as an input, generate a speech output corresponding to at least part of said digital content.

31. A computer program product stored in a memory comprising software instructions that, when executed in a mobile communication terminal, performs the method according to claim 1.
